(19) United States
(12) Patent Application Publication
(10) Pub. No.: US 2007/0154060 A1
(43) Pub. Date: Jul. 5, 2007

(54) Digital imaging device having watermarking capability

(75) Inventor: Kuo Chung Sun, Taipei (TW)

Correspondence Address: DUANE MORRIS LLP;IP DEPARTMENT (TSMC), 30 SOUTH 17TH STREET, PHILADELPHIA, PA, 19103-4196, US

(73) Assignee: Taiwan Semiconductor Manufacturing Co., Ltd.

(21) Appl. No.: 11/326,268

(22) Filed: Jan. 4, 2006

(51) Int. Cl. G06K 9/00

(52) U.S. Cl. 382/100

(57) ABSTRACT

A digital imaging device includes an image sensor for sensing an image of an object; an image data processor for encoding image data contained in a digital signal of the object sensed by the image sensor, into a digital image of the object; and a watermark generating unit for generating a digital watermark which is embedded in the digital image of the object. Further, a method of identifying a digital imaging device from a digital image of an object produced by the imaging device includes providing the digital imaging device with a watermark generating unit; and embedding a digital watermark generated by the watermark generating unit in the digital image of the object.

### FIELD OF THE INVENTION

The invention relates to steganography. More particularly, the invention relates to digital watermarking of digital still and moving pictures.

### BACKGROUND

One of the most significant breakthroughs in consumer electronics in the past 10 to 15 years is the process of converting analog information represented by a changing wave into digital information represented by bits (1s and 0s). This process has completely redefined how visual and audio information can be handled.

The digital camera is one of the most significant technologies which has come from this process. Non-digital cameras rely on chemical and mechanical processes to record an image of an object. Digital cameras, however, use an integrated computer to record an image (still or moving picture) in an electronic form.

Digital still and moving pictures can be easily edited, duplicated, and distributed without an owner's permission using current computer and internet technology. This, in turn, has lead to problems with copyright protection, ownership verification and authentication. These problems have been addressed by digital watermarking technology. In digital watermarking, a marking pattern of bits (digital watermark) is embedded into the digital image using a separate computer running watermarking software. The digital image is downloaded from the digital imaging device into the computer running the watermarking software. The computer embeds the digital watermark into the downloaded image such that the watermark is concealed or hidden in the image, so that it is not visible or perceptible to an observer when displayed, i.e., the watermarked image is visually identical to the original image. When viewing of the watermark is desired, it may be extracted and displayed by a computer running the appropriate extracting software.

Digital watermarking technology, therefore, enables the owner of the digital image to find unauthorized copies of the image. When found, the owner may take appropriate action against the person or entity copying the images.

In view of the foregoing, a digital imaging device is needed that is capable of embedding digital watermarks into the digital images it produces.

### SUMMARY

One aspect of the invention is a digital imaging device. The digital imaging device comprises an image sensor for sensing an image of an object; an image data processor for encoding image data contained in a digital signal of the object sensed by the image sensor, into a digital image of the object; and a watermark generating unit for generating a digital watermark which is embedded in the digital image of the object.

Another aspect of the invention is a method of identifying a digital imaging device from a digital image of an object produced by the imaging device. The method comprises providing the digital imaging device with a watermark generating unit; and embedding a digital watermark generated by the watermark generating unit in the digital image of the object.

### BRIEF DESCRIPTION OF THE DRAWINGS

FIG. 1 is a block diagram showing an embodiment of a digital imaging device of the invention.

FIG. 2 is a flowchart showing an embodiment of a method of identifying a digital imaging device from a digital image of an object produced by the imaging device.

### DETAILED DESCRIPTION

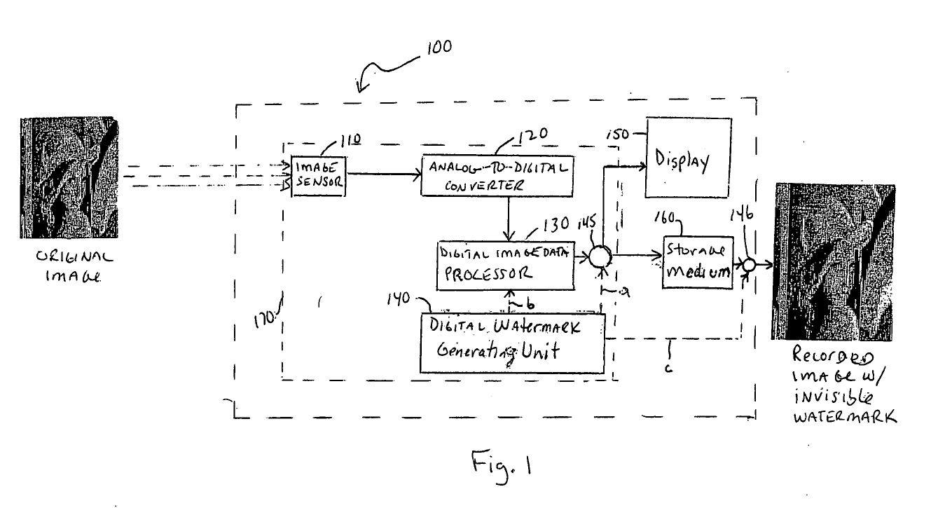

FIG. 1 is a block diagram showing an embodiment of a digital imaging device of the invention. The imaging device 100 may be a digital still image camera, a digital video camera, the digital camera portion of a digital camera cellular telephone or any other device which captures digital still or digital video images of objects.

In the shown embodiment, the imaging device 100 comprises an image sensor 110, an analog-to-digital converter 120, a digital image data processor 130, a digital watermark generating unit 140, adders 145 and 146, a display 150, and a storage medium 160. The image sensor 110, analog-to-digital converter 120, image data processor 130, watermark generating unit 140, and adders 145 and 146 may be implemented as one or more integrated circuits on one or more semiconductor chips 170 contained in the imaging device 100.

The image sensor 110 is used in the device for sensing an image of an object by opto-electrically transducing or converting light sensed from the object into an analog electric signal. The analog-to-digital converter 120 converts the analog electrical signal into a digital electrical signal. In one embodiment, the image sensor 110 may comprise any suitable and appropriate CCD (charge coupled device). In another embodiment, the image sensor 110 may comprise any suitable and appropriate CMOS (complementary metal oxide semiconductor) device.

The image data processor 130 encodes (compressing) image data contained in the digital signal so that a digital version of the sensed image of the object (digital image) may displayed on the display 150 or recorded on the storage medium 160, such as a memory card. The image data processor 130 may comprise any suitable image compressing system. For example, if the imaging device 100 comprises a digital still image camera or digital still camera section of camera cell phone, the image data processor 130 may comprise any suitable and appropriate JPEG (Joint Photographic Coding Experts Group) compressing system. In another example, if the imaging device 130 comprises a digital video camera, the image data processor may comprise any suitable and appropriate MPEG (Moving Picture Experts Group) image compressing system.

The watermark generating unit 140 generates an embedded, digital watermark , i.e., a pattern of bits representing the watermark. In one embodiment, the watermark generated by the watermark generating unit 140 may be embedded in the digital image by an adder 145 after encoding prior to the image being decoded and displayed on the display 150 or recorded on the storage medium 160 (broken arrow a). In another embodiment, the watermark generated by the watermark generating unit 140 is inputted into the image data processor 130 (broken arrow b) and embedded in the digital image during the encoding process by the image data processor 130. In still another embodiment, the watermark generated by the watermark generating unit 140 may be embedded in the digital image after encoding and after recording on the storage medium 160 by adder 146 (broken arrow c). The watermark generating unit 140 may be manually activated by the user of the imaging device 100 in a selective manner, and/or may be activated automatically whenever an image is recorded by the imaging device 100. In one embodiment, the watermark generating unit 140 is constructed and configured to embed the digital watermark in the encoded image data of the digital still picture (e.g., JPEG compression image) or the digital moving picture (e.g., MPEG compression image) so that it cannot be extracted by the corresponding watermark extracting system of the imaging device 100 or a digital image display device(e.g., a computer connected to the internet) when the digital image is displayed. Since the embedded watermark is not extracted when the corresponding extracting watermark system decodes back the image, it will not be viewable or perceptible to an observer in the displayed image, i.e., the watermarked image will be visually identical to its original.

In a preferred embodiment, the digital watermark generated by the watermark generating unit 140 comprises the serial number or identifier of the imaging device 100. The embedded serial number or identifier watermark may be used to identify the imaging device 100 through serial number or identifier matching as each imaging device typically has a unique serial number or identifier. In other embodiments, the digital watermark generated by the generating unit 140 may comprise a trademark, a logo, copyright notice information, other information, other images, and any combination thereof including the serial number or identifier of the imaging device 100.

The watermark generating unit 140 may use any suitable and appropriate watermarking algorithm to generate the embedded watermarks. In one embodiment, the watermark generating unit 140 may use a Fourier Transform-based algorithm to embed the watermark into the encoded image data of the digital still picture (e.g., JPEG compression image) or the digital moving picture (e.g., MPEG compression image) at unit 130. In an alternate embodiment, the watermark generating unit 140 may use a Wavelet Transform-based algorithm to generate the embedded watermarks. If a copy of the digital image produced by the imaging device of the invention is discovered, the owner of the imaging device can confirm ownership of the digital image by “extracting” the digital watermark from the copy of image and displaying the digital watermark. In one embodiment, the digital watermark may be extracted with a computer running a suitable watermark extracting software program. In another embodiment, the digital imaging device may be suitably configured to extract the digital watermark after a copy of the digital image file is uploaded into the device. In still a further embodiment, a copy of the image can be verified or the ownership authenticated by a third party service which owns or has rights to the watermark extraction technology.

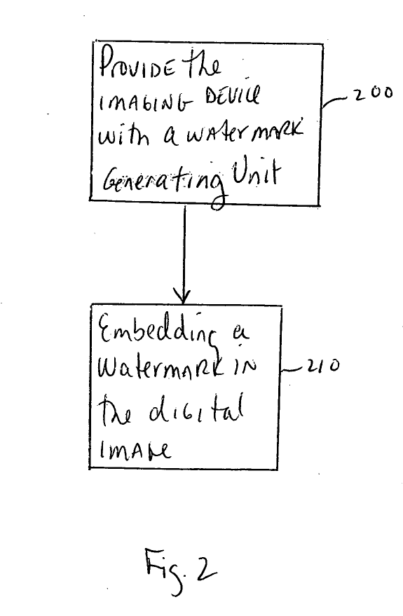

Another aspect of the invention is a method of identifying a digital imaging device from a digital image (of an object) produced by the imaging device. As shown in the flowchart of FIG. 2, the method comprises providing the digital imaging device with a watermark generating unit, in block 200, and embedding a digital watermark generated by the watermark generating unit in the digital image of the object, in block 210. As disclosed above, the digital watermark may comprise a serial number of the imaging device, the watermark generating unit may be provided as an integrated circuit on a semiconductor chip contained in the imaging device, and the watermark may be generated by a Fourier or Wavelet Transform-based algorithm executed by the watermark generating unit.

While the foregoing invention has been described with reference to the above, various modifications and changes can be made without departing from the spirit of the invention. Accordingly, all such modifications and changes are considered to be within the scope of the appended claims.

What is claimed is:

1. A digital imaging device comprising:
an image sensor for sensing an image of an object;
an image data processor for encoding image data contained in a digital signal of the object sensed by the image sensor, into a digital image of the object; and
a watermark generating unit for generating a digital watermark, which is embedded in the digital image of the object.

2. The digital imaging device of claim 1, further comprising an analog-to-digital converter for converting an analog electrical signal produced by the image sensor, into the digital signal.

3. The digital imaging device of claim 1, wherein the image sensor comprises one of a charge coupled device and a complementary metal oxide semiconductor device.

4. The digital imaging device of claim 1, further comprising an adder for embedding the watermark in the digital image of the object.

5. The digital imaging device of claim 1, further comprising a display for displaying the digital image of the object.

6. The digital imaging device of claim 1, further comprising a storage medium for storing the digital image of the object.

7. The digital imaging device of claim 1, wherein the digital watermark comprises a serial number or identifier of the imaging device.

8. The digital imaging device of claim 1, wherein the digital watermark is not visible to an observer in the digital image of the object.

9. The digital imaging device of claim 1, wherein the watermark generating unit is implemented as an integrated circuit on a semiconductor chip contained in the imaging device.

10. The digital imaging device of claim 1, wherein the digital imaging device comprises a digital still image camera.

11. The digital imaging device of claim 1, wherein the digital imaging device comprises a digital video image camera.

12. The digital imaging device of claim 1, wherein the image data processor comprises a Joint Photographic Coding Experts Group (JPEG) compressing system.

13. The digital imaging device of claim 1, wherein the image data processor comprises a Moving Picture Experts Group (MPEG) compressing system.

14. The digital imaging device of claim 1, wherein the watermark generating unit comprises a Fourier Transform-based algorithm for generating the watermark which is embedded into the digital image.

15. The digital imaging device of claim 1, wherein the watermark generating unit comprises a Wavelet Transform-based algorithm for generating the watermark which is embedded into the digital image.

16. A method of identifying a digital imaging device from a digital image of an object produced by the imaging device, the method comprising the steps of:
providing the digital imaging device with a watermark generating unit; and
embedding a digital watermark generated by the watermark generating unit in the digital image of the object.

17. The method of claim 16, wherein the digital watermark comprises a serial number or identifier of the imaging device.

18. The method of claim 16, wherein the step of providing is performed by implementing the watermark generating unit as an integrated circuit on a semiconductor chip contained in the imaging device.

19. The method of claim 16, wherein the watermark is generated by a Fourier Transform-based algorithm executed by the watermark generating unit.

20. The method of claim 16, wherein the watermark is generated by a wavelet Transform-based algorithm executed by the watermark generating unit.
